(19) United States
(12) Patent Application Publication
(10) Pub. No.: US 2006/0109612 A1
(43) Pub. Date: May 25, 2006

(54) Mounting assembly with intumescent layer for downlighters

(76) Inventor: Laurence Keith Kovacs, Stafford (GB)

Correspondence Address: SMITH-HILL AND BEDELL, P.C., 16100 NW CORNELL ROAD, SUITE 220, BEAVERTON, OR, 97006, US

(21) Appl. No.: 10/521,861

(22) PCT Filed: Jul. 18, 2003
(86) PCT No.: PCT/GB03/03229

§ 371 Date: Aug. 1, 2005

(30) Foreign Application Priority Data
Jul. 20, 2002 (GB) 0216915.9

(51) Int. Cl. H02B 1/00

(52) U.S. Cl. 361/665

(57) ABSTRACT

An assembly is described for use with downlighters incorporating an intumescent layer secured to a backer member such that the assembly conceals the downlighter when a fire is generated by the light fitting within the downlighter. The assembly comprises an expansion combination positioned with the combination secured to one part of a retention means whilst a cover over an opening for the downlighter is retained by another part of the retention means. The invention also provides retention means which are adjustable to allow the effective length of the mounting arrangement to be varied as required for specific installations.

The present invention relates to assemblies and more particularly to lighting assemblies of the so-called downlighter variety or embedded loud speakers.

In view of the heat generating capacity of lighting assemblies, they are a potential source of fires. However, a conventional suspended lighting assembly extending from a mounting rose in the ceiling is relatively safe. More recently use of downlighter lighter assemblies has become more fashionable as well as convenient in terms of allowing lower acceptable roof heights etc. Unfortunately, such downlighter assemblies require provision of a relatively wide aperture in the ceiling and/or roof space in order to accommodate the lighting fitting. Such apertures render it difficult to contain a fire in a room or for that matter a fire generated by failure of the light fitting itself. It will be understood that an aperture provides a pathway through which smoke and flames can pass. Ideally a closed barrier should be presented to a fire in order to at least contain it and preferably smother the fire through denial of oxygen.

In accordance with the present invention there is provided an assembly comprising an expansion combination comprising an intumescent layer and a backer member retained by retention means for expansion in use, when subjected to a predetermined temperature, towards an opening in a panel and/or cover in order to close the opening whereby the expansion combination is secured by one part of the retention means and the cover and/or panel secured by an other part of the retention means, the assembly characterized in that the one part of the retention means is axially displaceable in relation to the other part of the retention means for altering of the effective length of the assembly in the direction of expansion in use of the intumescent material towards the opening or cover.

Preferably, the expansion combination includes a pocket secured to the backer member and extending downward towards the opening.

Preferably, the expansion combination includes a cover layer to confine and/or protect the intumescent layer.

Typically, the backer member is relatively resilient and/or stable to provide a base for projecting expansion of the intumescent layer. Possibly, the backer member is formed from a fabric, paper or plastics material.

Normally, the type and/or thickness of the intumescent material in the intumescent layer depends upon the distance between the position at which the expansion combination is retained and the opening. Possibly, more than one expansion combination is provided in the assembly.

Preferably, the cover layer is perishable and/or flexible and/or displaceable in order not to inhibit expansion of the intumescent layer towards the opening or closure of the opening.

Normally, the intumescent and the backer layer of the expansion combination, along with the cover layer when provided, are secured together by securing means. Typically, the securing means may be perishable and/or rupturable stitching or adhesive or displaceable clips.

Preferably, the retention means comprises a down member which retains the expansion combination above the opening. Typically, the down member includes a ledge for the expansion combination. Normally, the ledge is provided by a bend or kink in the down member.

Preferably, the retention means includes an up member to secure the panel and/or cover.

Normally, adjustment means is provided between the down member and the up members to allow adjustment of the length of the retention means. Typically, the adjustment means comprises a screw thread bolt. Normally, a bias, such as a compression or expansion spring, is provided between the up member and the down member. Typically the bolt extends through the bias. Advantageously, the juxtaposed or overlapping ends are perpendicular to their respective up member and down member.

Advantageously, the adjustment means can be adjusted dependent upon a depth of thickness of a ceiling or structure into which the assembly is to be mounted. Generally, the retention means will be made from a metal or plastics material.

Normally, more than one retention means are provided to act in cooperation for the assembly. Generally, the juxtaposed or overlapping ends are flats upon which the adjustment means acts.

Typically, a cover end is secured to the cover or panel by securing means such as a screw fastening or pot rivet or other mechanical fixing or a recess or by ledge engagement. Possibly, the securing means will release when subjected to a temperature of a predetermined value such as during a fire.

Normally, the adjustment means includes lock means to lock the desired adjustment of the adjustment means.

Typically, the retention means will cooperate with any ventilation opening in a cover to facilitate heat dissipation caused by normal operation of a lighting element.

Possibly, the opening dosed by the expansion combination is one or more ventilation openings of a cover and/or any aperture in a cavity to accommodate the assembly.

An embodiment of the present invention will now be described by way of example only and with reference to the attached drawings in which:—

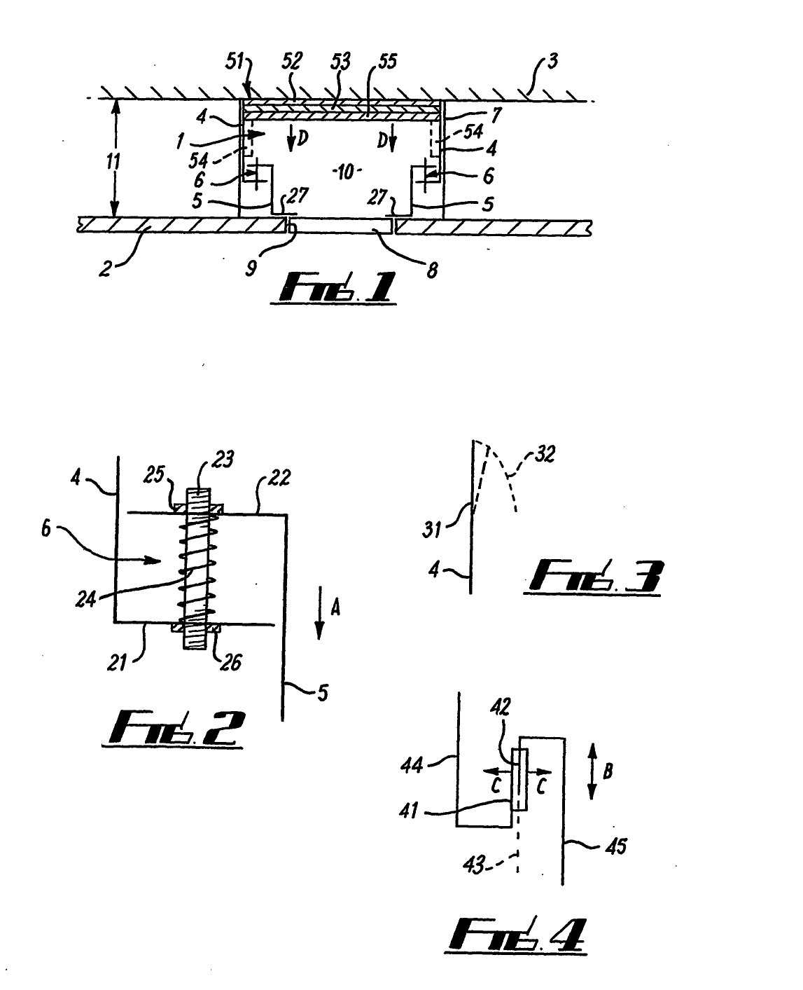

FIG. 1 is a schematic cross-section of a concealed fitting assembly such as that for a downlighter or loud speaker;

FIG. 2 is a schematic cross-section of an adjustment mechanism between members of the present assembly;

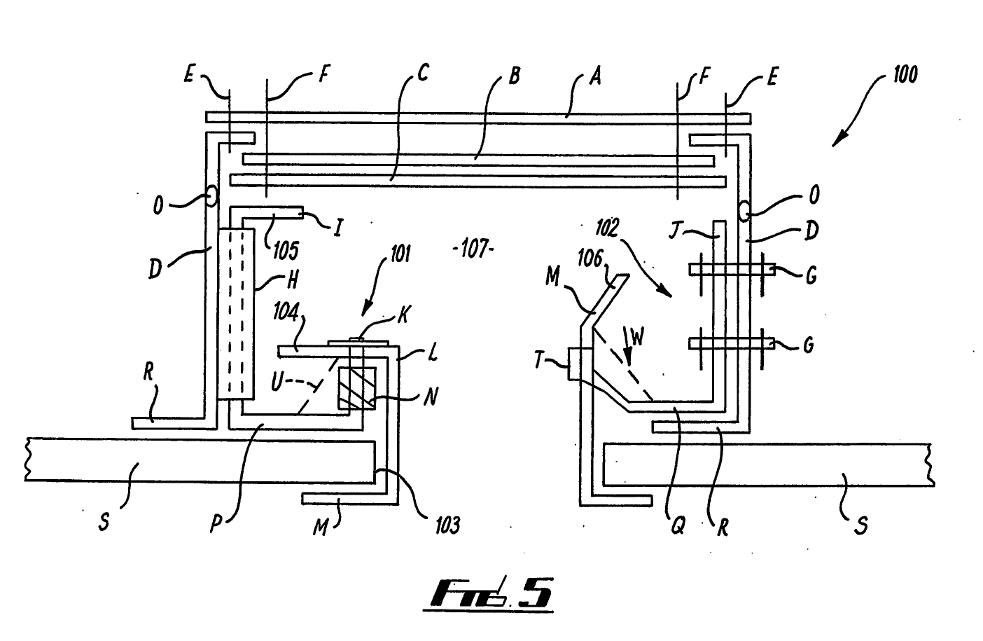

FIG. 3 is a schematic view of an up member in accordance with the present invention;

FIG. 4 is a schematic cross-section of an alternative adjustment mechanism in accordance with the present invention; and,

FIG. 5 is a further schematic illustration of an assembly in accordance with the present invention.

The present invention relates to a concealed fitment assembly such as for a so-called downlight lighting assembly or concealed loud speaker. These concealed fitment assemblies are generally mounted such that they are flat with a ceiling or wall or even floor surface. Thus, as seen in FIG. 1 an assembly 1 is provided between a panel or ceiling 2 and a support structure 3. The assembly comprises retention members 4, 5 with an adjustment mechanism 6 between them. Typically, the assembly 1 is located within a cavity or aperture 7 between the ceiling 2 and support structure 3.

The retention members 4, 5 respectively comprise a down member 4 and an up member 5. The down member 4 is secured at one end to the support structure 3. The up member 5 is secured to the ceiling 2 as well as where appropriate to a cover 8 for an opening 9 in the ceiling 2. Typically, the cover 8 may also include ventilation openings (not shown) along with a ventilation gap between the cover 8 and the opening 9 such that the heat generating lighting elements or other electrical device located within the cavity 10 of the assembly 1 does not overheat or present a fire hazard. It will also be understood that the aperture or cavity 7 may also be open to allow heat dissipation radially and horizontally into the space between the ceiling 2 and support structure 3. However, in such circumstances, in accordance with the present invention a pocket is normally provided around the assembly between the ceiling panel 2 and the support structure 3.

In accordance with the present invention an adjustment mechanism 6 is provided between the retention members 4, 5. Generally, the gap 11 between the ceiling 2 and support structure 3 may be different in specific installation locations for the assembly 1. Thus, to achieve appropriate assembly it is necessary to provide for at least lengthways adjustment of the retention members 4, 5 combination length.

FIG. 2 illustrates one embodiment of an adjustment mechanism 6 in accordance with the present invention. Essentially, the respective down member 4 and up member 5 present juxtaposed or overlapping end flats 21, 22. Thus, a screw thread rod or bolt 23 which extends through apertures (not shown) in the flats 21, 22 can be adjusted and so the combination length of the combination of members 4, 5 varied to that required for a particular installation. A bias is provided between the flats 21, 22 in order to ensure retention of the desired spacing and so combination length of the members 4, 5. This bias takes the form of a compression or extension spring 24 which acts to push the flats 21, 22 diametrically away from each other against locking members 25, 26 secured at each end of the rod or bolt 23.

It will be appreciated that by use of the bias 24 temporarily the up member 5 may be pulled or displaced downwards in the direction of arrow head A against the bias 24 such that, with a cover end 27 (FIG. 1) only secured to the cover 8, it may be possible to displace that cover 8 in order to gain access to the cavity 10.

As indicated above the cover end 27 of the up member 5 will generally be secured to at least a ceiling panel 2 or cover 8 or both. Thus, by adjustment of the adjustment mechanism 8 substantially the correct length of the combination of members 4, 5 can be achieved appropriate for the gap 11 between the ceiling 2 and support structure 3.

A top end of the down member 4 may be secured to the support structure 3. This support structure 3 may be a joist or the floorboards of an upper storey of a building. Alternatively, the top end of the down member 4 may simply rest against the support structure 3 if the panel 2 is sufficiently robust to support the assembly and fitment weight. In any event, as shown in FIG. 3 typically the upper end 31 will be bent or otherwise shaped in order to provide for appropriate fixing to the support structure 3. The end 31 will be bent in the direction of broken lines 32 in FIG. 3 such that it is suspended downwards towards the opening 9. The end 32 can be secured through a screw or nail or where appropriate an interference connection such as a bayonet fitting.

Normally several retention member 4, 5 combinations will be provided in opposed but co-operative relationships in order to support the ceiling panel 2 and/or the cover 8. In such circumstances, the adjustment mechanism 6 allows for differences in the necessary gap 11 between respective retention member 4, 5 combinations.

An alternative adjustment mechanism for the present assembly is illustrated in schematic cross-section in FIG. 4. Thus, a down member 44 presents a sleeve end 41 to a spigot end 42 of an up member 45. The sleeve end 41 accommodates the spigot end 42 to allow adjustment upwards and downwards in the direction of arrow heads B and therefore adjustment of the length of the members 44, 45 as a combination for an assembly in accordance with the present invention As illustrated in FIG. 4, the spigot end 42 can overlay the sleeve end 41 or alternatively be presented in a direct upward orientation as shown by broken lines 43. In any event, when the desired length of member 44, 45 combination is achieved, the sleeve end 41 and spigot end 42 location can be locked by bending or other distortion in the direction of arrow heads C to retain the desired relative positions. With a spigot end 43 which extends upwardly it will be appreciated that part of the end 43 which extends beyond the sleeve end 41 may be bent over to retain appropriate location.

With regard to fire protection and in particular the spread of fire as indicated previously the openings 9 and other apertures of a concealed fitting assembly are a potential danger. Thus, in accordance with the present invention an expansion combination 51 is provided. This combination 51, basically comprises a base or backer member 52 and an intumescent layer 53 such that upon reaching a predetermined temperature the intumescent layer expands both vertically and horizontally towards the opening 9 in order to close that opening. As illustrated in FIG. 1 the expansion combination 51 can be a simple disc at one end of the cavity 7 which extends downwardly in the direction of arrow heads D towards the opening 9. Alternatively, the combination 51 may also include side portions 54 illustrated with broken lines to provide further intumescent material which expands with temperature in order to fill the cavity 7 and so close the opening 9 more rapidly. In order to protect the intumescent material in particular a cover layer 55 is normally provided to protect the intumescent material from which the intumescent layer 53 is formed from contamination and other damage. Typically, the cavity 7 is lined with a pocket of flexible material such as a fabric. Where there is no cavity a pocket is simply provided which extends downward from the expansion combination 51. The pocket is only secured to the backer member 52 within the combination 51.

The backer member 52 provides a base for the combination 51 from which expansion of the intumescent layer 53 can project. Typically, the backer member is made from a relatively robust and incombustible material. The backer member 52 may be a fabric, a plastics material or a metal to provide a relatively stable and resilient base from which the intumescent layer 53 projects downwardly and horizontally in order to fill the cavity 7 or pocket, and so dose the opening 9 and any other apertures for ventilation etc.

The intumescent layer 53 as indicated previously is made from essentially intumescent material. Such materials are well known It will be understood that the thickness of intumescent material used in the intumescent layer 53 will depend upon the size of gap 11 as well as the type of intumescent material used. A number of expansion combinations 51 may be provided within the same assembly in accordance with the present invention.

As illustrated in FIG. 1 normally the backer member 52 will rest against the support structure 3 but alternatively could be located upon a recess or pocket in the down member 4 at a desired position but then dependent on the strength of the backer member 52 in order to provide the stable base from which the intumescent layer projects towards the opening 9.

The expansion combination 51 is normally securely located by inward bending of the end 31 in order to provide a compression fitting within the assembly 1.

As indicated previously there may be significant differences in the gap 11 between the ceiling 2 and support structure 3 between different installations. In accordance with the present invention a retention mechanism comprising members 4,5 is provided with an adjustment mechanism 6 which defines a range of potential lengths for the combination members 4, 5. Thus, an expansion combination 51 can be provided which will achieve acceptable results in terms of time for closure and displacement range for temperature for the maximum length of the combination of members 4, 5. In such circumstances if the actual installation length of members 4, 5 in combination is less than this maximum length then the intumescent material in the layer 53 will simply be more effective in terms of speed of closure etc.

As indicated above normally the present assembly will be located within a cavity or aperture between the ceiling 2 and support structure 3. This may be created by simple excavation of material between the ceiling 2 and structure 3 but will normally be created by a pocket specifically associated with the assembly. This pocket is flexible in order to accommodate the full displacement length of the retention members 4, 5 combination. Normally the pocket will be made from a fabric or an elastomeric sheet. In such circumstances the cavity 7 will be created as a specific pocket associated with the assembly 1. The walls of that pocket will be secured only to the backer member 52 such that there is no restraint upon expansion displacement of the intumescent layer 52 towards the opening 9.

The expansion combination 51 is generally held together through a securing mechanism. This securing mechanism may comprise stitching or adhesive or a clip between the respective layers 52, 53, 55 of the combination 51. In any event, upon activation through exposure to the temperature at which the intumescent material expands the securing mechanism whether it be stitching or adhesive or clips or a combination of these features will readily be displaceable or ruptured in order to allow expansion of the intumescent layer 53 towards the opening 9. It will also be understood that the cover layer 55 is perishable, displaceable or sufficiently flexible such that there is no obstruction or constriction or any inhibition of the expansion of the intumescent layer 52 towards the opening 9. In such circumstances, the securing mechanism and/or the cover layer 55 will be made from materials which melt or burn or otherwise lose their mechanical strength at relatively low temperatures compared to that for substantial expansion of the intumescent material of layer 53.

The present assembly can take the form of a circular, square, rectangular, triangular or any other cross-section provided the intumescent material projects towards the opening 9 and any other apertures in order to dose them and therefore inhibit fire or smoke propagation problems.

As indicated above it is preferable where a cavity 7 is not provided normally by the materials between the ceiling 2 and structural support 3 that a pocket is created and secured at least to the backer member 52 and possibly the ceiling panel 2. This pocket will be made from a relatively incombustible fabric or similar material to provide the extensibility and flexibility over the combination length range provided by the retention members 4, 5. The seams of this pocket will be made from an incombustible thread to ensure the pocket remains substantially inert at the elevated temperatures and so provide confinement of the intumescent material expansion towards the opening 9 to dose it as required. It will be understood that the gap 11 between the ceiling 2 and the support structure 3 may be filled with thermal insulating or sound proofing material such that the pocket may be reinforced by the insulating material. Alternatively, specific reinforcing rods or concertinaring in the pocket may be provided in order to further resist horizontal expansion of the intumescent material and therefore provide preferential expansion towards the opening 9 for closure.

FIG. 5 illustrates in further detail a schematic cross-section of an assembly 100 in accordance with the present invention. The assembly 100 incorporates alternative retention arrangements 101 and 102 but normally the same type of retention arrangement will be provided throughout the assembly 100 in a practical embodiment. Essentially, a ceiling panel S includes an opening 103 about which an up-member M is secured. The up-member M is associated through an adjustment mechanism with a down-member described later with respect to retention arrangement 101, 102 respectively. A pocket or side wall D of a cavity extends upwardly from the ceiling panel S and is generally associated with the up-member of the assembly. An expansion combination comprising a backer or top member A, intumescent layer B and a cover layer C is provided. The expansion combination is secured together through stitching F, which as indicated previously, will melt or burn away at relatively low temperatures such that the intumescent layer B can expand towards the opening 103. The backer member A is secured to the pocket or cavity D through non-combustible fixings, thread or staples E Thus, it will be appreciated that the embodiment of the assembly according to the present invention depicted in FIG. 5 is consistent with that described with regard to previous FIGS. 1 to 4.

The retention arrangement 101 as indicated above, includes an up-member M with an adjustment mechanism comprising a lock member K secured on an up-right from the down-member P. Flat portions between the up-member M and the down-member P are utilised by a spring N in order to retain relative association there between, and provide an adjustable length for the combination of up-member M and down-member P. Normally, as indicated, an end section 104 will be bent over in the direction of broken line U in order to lock the position of members M, P. In the retention arrangement 101, a sleeve H is provided in the pocket or cavity wall D to secure location of the up-member P. Again, an end portion 105 of the up-member P is bent over such that a section I is inwardly projecting in order to lock the position of the up-member P relative to the sleeve H and therefore pocket or cavity D. In such circumstances, the combination length of the up-member M and down-member P can be adjusted as required through the up-right and locking member K whilst the pocket D includes an end R bent outwardly to an extent dependent upon the length required. Clearly, the section I is also bent to an extent dependent upon the desired length for installation. In any event, the intumescent layer B can then project downwardly towards the opening 103 in order to close it as well as any ventilation holes O in the pocket or cavity D.

Retention arrangement 102 similarly comprises an up-member M which extends through a sleeve or channel T in the down-member Q. Thus, the combination length of the up-member M and down-member Q can be adjusted through movement of the member M in the channel T and then bending over an end 106 in the direction of arrowhead W to lock that position. The up-member Q is secured to the cavity or pocket D through mechanical fixings G such as rivets or screws. In such circumstances, although it is possible for the mechanical fixings G to be located at different points in the cavity or pocket D it is more convenient if the down-member Q is initially fixed relative to the cavity or pocket D whilst adjustment is through relative displacement of the up-member within the channel or sleeve T. It will be noted in the retention arrangement 102 it is possible for the pocket end R to be folded inwards as illustrated in order to reduce the “footprint” of the assembly 100 in accordance with the present invention. Furthermore, an end J of the up-member Q may be bent over to further retain location of the up-member Q relative to the mechanical fixings G. Again, the expansion combination and in particular the intumescent layer B will extend downwardly towards the opening 103 in order to close it as well as any ventilation aperture O in the pocket or cavity D.

As indicated previously, the backer member A can be secured to a structural support but provided the ceiling panel S is sufficiently robust to support the weight of the assembly 100 and any fitment in the cavity 107 then the backer member A need not be secured to a structural support but merely be in a juxtaposed position against the support. Furthermore, if there is sufficient space the backer member A may be spaced from any other surface.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-30. (canceled)

31. An assembly comprising an expansion combination comprising an intumescent layer and a backer member retained by retention means for expansion in use, when subjected to a predetermined temperature, towards an opening in a panel and/or cover in order to close the opening whereby the expansion combination is secured by one part of the retention means and the cover and/or panel secured by an other part of the retention means, the assembly characterized in that the one part of the retention means is axially displaceable in relation to the other part of the retention means for altering of the effective length of the assembly in the direction of expansion in use of the intumescent material towards the opening or cover.

32. An assembly as claimed in claim 31 wherein the expansion combination comprises a pocket secured to the backer member and extending downwards towards the opening.

33. An assembly as claimed in claim 31 wherein the expansion combination includes a cover layer to confine and/or protect the intumescent layer.

34. An assembly as claimed in claim 31 wherein the backer member is relatively resilient and/or stable to provide a base for projection expansion of the intumescent layer.

35. An assembly as claimed in claim 31 wherein the backer member is formed from a fabric, paper or plastics material.

36. An assembly as claimed in claim 31 wherein the type and/or thickness of the intumescent material in the intumescent layer depends upon the distance between the position at which the expansion combination is retained and the opening.

37. An assembly as claimed in claim 31 wherein the assembly incorporates more than one expansion combination.

38. An assembly as claimed in claim 31 wherein the cover layer is perishable and/or flexible and/or displaceable in order not to inhibit expansion of the intumescent layer towards the opening or closure of the opening.

39. An assembly as claimed in claim 31 wherein the intumescent layer and the backer layer of the expansion combination, along with the cover layer when provided are secured together by securing means.

40. An assembly as claimed in claim 39 wherein the securing means is perishable and/or rupturable stitching or adhesive or displaceable clips.

41. An assembly as claimed in claim 31 wherein the retention means comprises a down member which retains the expansion combination above the opening.

42. An assembly as claimed in claim 41 wherein the down member includes a ledge for the expansion combination.

43. An assembly as claimed in claim 42 wherein the ledge is provided by a bend or kink in the down member.

44. An assembly as claimed in claim 31 wherein the retention means includes an up member to secure the panel and/or cover layer when provided.

45. An assembly as claimed in claim 44 wherein the retention means comprises a down member which retains the expansion combination above the opening and wherein the down member and the up member include respectively juxtaposed or overlapping ends to form when secured together the retention means.

46. An assembly as claimed in claim 44 wherein adjustment means is provided between the down member and the up member to allow adjustment of the length of the retention means for altering the effective length of the assembly.

47. An assembly as claimed in claim 44 wherein the adjustment means comprises a screwthread bolt.

48. An assembly as claimed in claim 44 wherein a bias, such as a compression or expansion spring, is provided between the up member and the down member.

49. An assembly as claimed in claim 47 wherein a bias, such as a compression or expansion spring, is provided between the up member and the down member and the bolt extends through the bias.

50. An assembly as claimed in claim 44 wherein the respective up member and down member have juxtaposed or overlapping ends which are substantially perpendicular.

51. An assembly as claimed in claim 46 wherein the adjustment means can be adjusted dependent upon a depth of thickness of a ceiling or structure into which the assembly is to be mounted.

52. An assembly as claimed in claim 31 wherein the retention means is made from a metal or plastics material.

53. An assembly as claimed in claim 31 wherein the assembly incorporates more than one retention means to act in cooperation.

54. An assembly as claimed in claim 45 wherein the juxtaposed or overlapping ends are flats upon which the adjustment means acts in use.

55. An assembly as claimed in claim 31 wherein a cover end is secured to the cover or panel by securing means such as a screw fastening or pop rivet or other mechanical fixing or a recess or by ledge engagement.

56. An assembly as claimed in claim 46 wherein the adjustment means includes lock means to lock the desired adjustment of the adjustment means.

57. An assembly as claimed in claim 53 wherein the retention means cooperates with a ventilation opening in a cover to facilitate heat dissipation caused by normal operation of a lighting element.

58. An assembly as claimed in claim 31 wherein the opening which is closed by the expansion combination is one or more ventilation openings of a cover and/or an aperture in a cavity to accommodate the assembly.
